(19) United States
(12) Patent Application Publication
(10) Pub. No.: US 2005/0205829 A1
(43) Pub. Date: Sep. 22, 2005

(54) Silicone composition and process useful for improving the coefficient of friction of an airbag, for protecting an occupant of a vehicle

(75) Inventors: Frederic Magd, Lyon (FR); Laurent Dumont, La Motte Servolex (FR); Alain Pouchelon, Meyzieu (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: RHODIA CHIMIE, BOULOGNE-BILLANCOURT (FR)

(21) Appl. No.: 11/000,441

(22) Filed: Dec. 1, 2004

Related U.S. Application Data
(60) Provisional application No. 60/536,232, filed on Jan. 14, 2004.

(30) Foreign Application Priority Data
Dec. 1, 2003 (FR) 03/14064

(51) Int. Cl. B32B 5/02

(52) U.S. Cl. 252/8.61

(57) ABSTRACT

A process and a composition for improving the coefficient of friction of coated fabrics suitable as inflatable bags feature a silicone coating composition containing an additive including particles of a resin (III) which comprises at least one (co)polyamide; after coating the composition onto fabric supports and curing, the coated supports show optimum properties in terms of coefficient of friction.

### CROSS-REFERENCE TO PRIORITY/PROVISIONAL APPLICATIONS

This application claims priority under 35 U.S.C. § 119 of FR 03/14064, filed Dec. 1, 2003, and of provisional application Ser. No. 60/536,232, filed Jan. 14, 2004, each hereby expressly incorporated by reference and each assigned to the assignee hereof. This application is also a continuation of said '232 provisional.

### BACKGROUND OF THE INVENTION

1. Technical Field of the Invention

The general field of the invention is that of silicone coating compositions, in particular those of the two-pack or multi-pack type, which can be cured by polyaddition or hydrosilylation reactions to produce an elastomer as a thin layer. These cured compositions are adapted, inter alia, as coatings, for example for the protection or the mechanical reinforcement of various textile substrates, for instance fibrous, woven, knitted or nonwoven supports.

Such silicone coatings are generally obtained by coating the substrate and then curing, resulting from the polyaddition of unsaturated groups (alkenyls, e.g., Si-Vi) of a polyorganosiloxane onto hydrogens of the same or of another polyorganosiloxane.

2. Description of Background and/or Related and/or Prior Art

At the present time, many motor vehicles are equipped with an acceleration sensor that measures the decelerations of the vehicle. When the reference deceleration value is exceeded, an explosive pellet triggers the combustion of an additional charge, and then that of the combustible solid; this solid is converted into gas (for example nitrogen) and inflates the cushion. For further details regarding these personal protection bags or “airbags”, reference may be made especially to FR-A-2-668,106.

Historically, these bags are formed by a web of synthetic fiber, for example polyamide, coated on at least one of its faces with a layer of an elastomer such as chloroprene. An airbag (or inflatable cushion) is an air-filled bag made of pleated and tight-stitched polyamide fabric. Silicone compositions have easily supplanted chloroprenes in this application, since it turns out that chloroprenes do not satisfy all the above-targeted specifications.

These silicone compositions have thus found an important application in the coating of flexible—woven, knitted or nonwoven—materials used for manufacturing personal protection bags for the occupants of vehicles, also known as “airbags”.

Thus, the present invention relates to the application of silicones to the manufacture of such protective bags.

Frontal airbags may be adaptive and may be deployed proportionally to the force of the impact. They may be supplemented with side airbags and curtains. The presence of such a protective coating or layer is dictated by the fact that the gases liberated by the gas generator in the event of an impact are extremely hot and contain incandescent particles liable to damage the Nylon® bag.

The inner elastomeric protective layer must thus be particularly resistant to high temperatures and to mechanical stresses. It is also important for this elastomeric coat to be in the form of a thin, uniform film that adheres fully to the synthetic fabric support, forming the walls of the airbag. However, when the silicone deposit increases, an increase in the coefficient of friction is observed, i.e., a degradation of the slipperiness properties of the airbag. Furthermore, when the silicone layer is on the outer face of the airbag, it ensures the leaktightness of the bag after deployment and inflation.

That aside, these inflatable bags must be made out of fabrics that have good slipperiness properties and a good coefficient of friction so as not to retard the deployment of the bag, while at the same time not jeopardizing the other expected properties, or even enhancing them, especially the fire resistance, the heat resistance, the crease resistance and the abrasion resistance (“scrub test”), the tear strength and the combing strength. These good slipperiness properties are also necessary to improve the manual positioning of an airbag under the siting markers during its manufacture, especially during the operations of stitching and reinforcing the area around the generator. Better slipperiness properties also make it possible to reduce the risk of injuries to the passenger's face.

The prior art EP-A-0,533,840 and U.S. Pat. No. 5,296,298 describe silicone compositions for airbag applications. According to EP-A-0,553,840, these known silicone compositions comprise:
(A) a polydiorganosiloxane containing at least two alkenyl groups per molecule,
(B) a polyorganohydrogenosiloxane containing at least two hydrogen atoms linked to silicon in each molecule,
(C) a metallic catalyst of the platinum group,
(D) an adhesion promoter consisting of an epoxy-functional organosilicon compound,
(E) a mineral filler, the weight amount of which is defined relative to the amount of the polyorganosiloxane (A),
(F) a resin polyorganosiloxane, and optionally
(G) a compound that is useful as a curing inhibitor.

However, the said reference only presents solutions for obtaining homogeneous and adhesive films for airbag coatings and is silent as regards solving the problem mentioned above.

According to U.S. Pat. No. 5,296,298, these silicone compositions comprise:
(A) a polydiorganosiloxane containing at least two alkenyl groups per molecule,
(B) a polyorganohydrogenosiloxane containing at least two hydrogen atoms linked to silicone in each molecule,
(C) a silane containing a methacrylic function,
(D) an epoxyalkoxysilane,
(E) an aluminum chelate, and
(F) a metallic catalyst of the platinum group.

The said reference provides solutions only for obtaining silicone films that show good adhesion on the airbag support. These compositions are not adapted to the new expectations of airbag manufacturers as regards controlling the slipperiness properties of the airbag.

EP-A-0,681,014 describes a silicone composition, which may be applied especially as an airbag lining and which has for this purpose good properties especially in terms of fire resistance and heat resistance, mechanical properties, aging behavior, adhesion and surface uniformity, the adhesion to textile substrates being more particularly desired. The solution proposed by the said invention entails utilizing:

a silicone coating composition that is a mixture of:

(1) at least one polyorganosiloxane containing, per molecule, at least two C2-C6 alkenyl groups linked to silicon,
(2) at least one polyorganosiloxane containing, per molecule, at least two hydrogen atoms linked to silicon,
(3) a catalytically effective amount of at least one catalyst, of a metal belonging to the platinum group,
(4) an adhesion promoter,
(5) optionally, a mineral filler,
(6) optionally, at least one curing inhibitor, and
(7) optionally, at least one polyorganosiloxane resin,
   in which composition the adhesion promoter is exclusively an at least ternary combination of the following ingredients:
(4-1) at least one alkoxylated organosiloxane containing, per molecule, at least one C2-C6 alkenyl group,
(4-2) at least one organosilicon compound comprising at least one epoxy radical, and
(4-3) at least one metal chelate M and/or a metal alkoxide of general formula: M(OJ)n, with n=valency of M and J=linear or branched C1-C8 alkyl, M being selected from the group consisting of: Ti, Zr, Ge, Li, Mn, Fe, Al and Mg.

These formulations have the drawback in that the elastomer obtained may have a more or less tacky feel, which, besides the unpleasant handle, may be detrimental to the mechanical behavior and properties of the coated support. In the field of inflatable bags for protecting the occupants of a vehicle, given that the deployability of the bag depends especially on the value of the coefficient of friction, an improvement would be particularly welcome.

These compositions are therefore not adapted to the new expectations of airbag manufacturers as regards controlling the slipperiness properties of the airbag.

French Patent No. 2,765,884 describes a silicone composition comprising, as a mixture:
(1) at least one polyorganosiloxane containing, per molecule, at least two C2-C6 alkenyl groups linked to silicon,
(2) at least one polyorganosiloxane containing, per molecule, at least two hydrogen atoms linked to silicon,
(3) a catalytically effective amount of at least one catalyst, comprising at least one metal belonging to the platinum group,
(4) an adhesion promoter,
(5) optionally, a reinforcing system, which may be at least one polyorganosiloxane resin and/or at least one reinforcing filler,
(6) optionally, at least one curing inhibitor, and
(7) organic or mineral hollow microspheres.

These expandable organic microspheres comprise a polymer wall containing a liquid or a gas. The expansion of these microspheres is brought about by heating the polymer beyond the softening point and to a temperature that is sufficient to vaporize the liquid or to appropriately dilate the gas, which may be, for example, an alkane such as isobutane or isopentane. The polymers used in its walls are prepared from vinyl chloride, vinylidene chloride, acrylonitrile, methyl methacrylate or styrene monomers or from acrylonitrile/methacrylonitrile or acrylonitrile/vinylidene chloride copolymer.

However, the product obtained by this type of composition after curing is a foam whose mechanical properties (for example the combing strength) are insufficient. It is thus desirable to find an alternative to this type of composition.

### SUMMARY OF THE INVENTION

The present invention is directed towards ameliorating/overcoming the disadvantages and drawbacks of the prior art.

In this perspective, the present invention features a process for improving the coefficient of friction of a woven, knitted or nonwoven fibrous support. These supports treated by means of the process according to the invention are useful especially for applications in the field of inflatable safety bags for vehicles, or airbags.

The present invention also features a silicone coating composition that may be cured by polyaddition or free-radical reactions, which is useful especially for applications in the field of inflatable safety bags for vehicles, or airbags, and which has, after curing and coating on a fabric, optimum properties in terms of slipperiness, i.e., a good coefficient of friction.

Too, this invention also features a curable silicone coating composition for airbags that is easy to use and to apply, and that is also economical.

This invention also features a woven, knitted or nonwoven fibrous support coated on one or two faces with a silicone elastomer according to the invention, which is particularly useful in the field of airbags.

More specifically, the present invention features a process for improving the coefficient of friction of a woven, knitted or nonwoven fibrous support, comprising the following steps:
a) the preparation of a curable silicone coating composition (A) comprising:
   (1) components (a-1) or (a-2):
   (a-1) corresponding to at least one polyorganosiloxane that may be cured by the action of a catalyst based on at least one organic peroxide, and
   (a-2) corresponding to a polyorganosiloxane blend that may be cured by polyaddition reactions, comprising:
   at least one polyorganosiloxane (I) containing, per molecule, at least two C2-C6 alkenyl groups bonded to silicon, and
   at least one polyorganosiloxane (II) containing, per molecule, at least two hydrogen atoms bonded to silicon,
   (2) an effective amount of curing catalyst which comprises: when (a-1) is used, of at least one organic peroxide, and when (a-2) is used, of at least one metal (or compound) of the platinum group,
   (3) particles of at least one resin (III) comprising at least one (co)polyamide,
   (4) optionally, at least one reinforcing filler,
   (5) at least one adhesion promoter (IV),
   (6) optionally, an additive system (B), the constituents of which are added sequentially or simultaneously, which comprises a mixture of:
   at least one polyorganosiloxane resin (V) present at up to 60% by weight relative to the total weight of the mixture and optionally mixed with at least one polyorganosiloxane serving as diluent, and
   calcium carbonate (CaCO₃) present at up to 30% by weight relative to the total weight of the mixture;
   (7) optionally, at least one curing inhibitor (VI),
b) the application of at least 10 g/m², to one or two faces of a woven, knitted or nonwoven fibrous support of the silicone coating composition (A) prepared in step a), and
c) the curing of the deposit formed in step b) to form an elastomer by heating to a temperature that may be up to 210° C., by electromagnetic radiation, in particular by infrared radiation.

### DETAILED DESCRIPTION OF BEST MODE AND SPECIFIC/PREFERRED EMBODIMENTS OF THE INVENTION

The presence of the particles of the resin (III) comprising at least one (co)polyamide has the effect of increasing the coarseness of the coating, which results in a reduction in the coefficient of friction without deteriorating the mechanical properties of the fabric.

Preferably, the particles of the resin (III) comprise at least one (co)polyamide selected from the group consisting of: polyamide-6, polyamide-6.6, polyamide-4, polyamide-11, polyamide-12, polyamides 4-6, 6-10, 6-12, 6-36 and 12-12, and copolymers and blends thereof.

In accordance with one preferred embodiment, the particles of the resin (III) comprise polyamide-12.

In another preferred embodiment, the particles of the resin (III) are of spherical shape.

The (co)polyamide particles will preferably have a mean diameter of from 5 to 100 μm and in particular from 10 to 50 μm.

These particles are preferably present at up to 40% by weight, preferably in a proportion of from 1% to 30% by weight and even more preferably in a proportion of from 5% to 20% by weight relative to the total weight of the mixture.

The polyorganosiloxane (a1) that is curable by the action of a catalyst based on at least one organic peroxide is advantageously a product containing siloxyl units of formula:

$${R}_{a}^{1} SiO \frac{( 4 - a )}{2} \qquad ( I \text{-} 1 )$$

in which:
the symbols R¹, which may be identical or different, are each a hydrocarbon-based group containing from 1 to 12 carbon atoms and preferably from 1 to 8 carbon atoms, which is optionally substituted, and
a is 1, 2 or 3.

Preferably, the symbols R¹ are selected from among:

methyl, ethyl, propyl, butyl, hexyl and dodecyl radicals, cycloalkyl radicals, for instance the cyclohexyl radical, alkenyl radicals, for instance vinyl, allyl, butenyl and hexenyl radicals, aryl radicals, for instance phenyl, tolyl and aralkyl radicals such as the β-phenylpropyl, radical, and
the radicals mentioned above in which one or more hydrogen atoms are replaced with one or more halogen atoms, a cyano group or a cyano group equivalent, for instance a chloromethyl, trifluoropropyl or cyanoethyl radical.

Even more preferentially, the polyorganosiloxanes (a-1) are terminated at the chain ends with trimethylsilyl, dimethylvinyl, dimethylhydroxysilyl or trivinylsilyl units.

In one particularly advantageous embodiment, the polyorganosiloxanes (a-1) contain at least two alkenyl groups per molecule.

Among the organic peroxides that may be used according to the invention, representative are benzoyl peroxide, bis(p-chlorobenzoyl) peroxide, bis(2,4-dichlorobenzoyl) peroxide, dicumyl peroxide, di-t-butyl peroxide, 2,5-dimethyl-2,5-di(t-butylperoxy)hexane, t-butyl perbenzoate, t-butylcumyl peroxide, halogenated derivatives of the peroxides mentioned above, for instance bis(2,4-dichlorobenzoyl) peroxide, 1,6-bis(p-toluoylperoxycarbonyloxy)hexane, 1,6-bis-(benzoylperoxycarbonyloxy)hexane, 1,6-bis(p-toluoyl-peroxycarbonyloxy)butane and 1,6-bis(2,4-dimethylbenzoylperoxycarbonyloxy)hexane.

The polyorganosiloxane (I) of the silicone coating composition (A) employed for the mode of curing by means of polyaddition reactions comprises:

(i) siloxyl units of formula:

$${R}_{a}^{1} {Z}_{b} SiO \frac{4 - ( a + b )}{2} \qquad ( I \text{-} 1 )$$

in which:
the symbols R¹ are each an alkenyl radical, preferably vinyl or allyl,
the symbols Z, which may be identical or different, each represent a monovalent hydrocarbon-based group, free of unfavorable action on the activity of the catalyst and selected from among alkyl radicals containing from 1 to 8 carbon atoms inclusive, optionally substituted with at least one halogen atom, and also from among aryl radicals,
a is 1 or 2, b is 0, 1 or 2 and the sum a+b is equal to 1, 2 or 3, and optionally
(ii) other siloxyl units of formula:

$${Z}_{c} SiO \frac{( 4 - c )}{2} \qquad ( I \text{-} 2 )$$

in which:
Z has the same definition as above and c is 0, 1, 2 or 3.

This polydiorganosiloxane (I) may have a viscosity at least equal to 200 mPa·s and preferably less than 200,000 mPa·s.

All the viscosities referred to herein correspond to a dynamic viscosity magnitude that is measured, in a manner that is known per se, at 25° C.

The polyorganosiloxane (I) may be formed solely from units of formula (I-1) or may contain, in addition, units of formula (I-2). Similarly, it may have a linear, branched, cyclic or network structure. Z is generally selected from among methyl, ethyl and phenyl radicals, 60 mol % (or in numerical terms) at least of the radicals Z being methyl radicals. Examples of siloxyl units of formula (I-1) are vinyldimethylsiloxyl, vinylphenylmethylsiloxyl, vinylmethylsiloxyl and vinylsiloxyl units.

Examples of siloxyl units of formula (I-2) are the units SiO_{4/2}, dimethylsiloxyl, methylphenylsiloxyl, diphenylsiloxyl, methylsiloxyl and phenylsiloxyl. Examples of polyorganosiloxanes (I) are linear and cyclic compounds, for instance: dimethylpolysiloxanes containing dimethylvinylsilyl end groups, (methylvinyl)(dimethyl)polysiloxane copolymers containing trimethylsilyl end groups, (methylvinyl)(dimethyl)polysiloxane copolymers containing dimethylvinylsilyl end groups and cyclic methylvinylpolysiloxanes.

Advantageously, the polyorganosiloxane (II) comprises siloxyl units of formula:

$${H}_{d} {L}_{e} SiO \frac{4 - ( d + e )}{2} \qquad ( II \text{-} 1 )$$

in which:
the groups L, which may be identical or different, each represent a monovalent hydrocarbon-based group, free of unfavorable action on the activity of the catalyst and selected, preferably, from among an alkyl radical containing from 1 to 8 carbon atoms inclusive, optionally substituted with at least one halogen atom, advantageously from methyl, ethyl, propyl and 3,3,3-trifluoropropyl radicals, and aryl radicals, and advantageously a xylyl, tolyl or phenyl radical,
d is 1 or 2, e is 0, 1 or 2, the sum d+e is equal to 1, 2 or 3, and
optionally, at least some of the other units being units of mean formula:

$${L}_{g} SiO \frac{4 - g}{2} \qquad ( II \text{-} 2 )$$

in which the groups L have the same definition as above and g is equal to 0, 1, 2 or 3.

The dynamic viscosity of this polyorganosiloxane (II) is at least equal to 10 mPa·s and preferably between 20 and 1000 mPa·s. The polyorganosiloxane (II) may be formed solely from units of formula (II-1) or may also comprise units of formula (II-2). The polyorganosiloxane (II) may have a linear, branched, cyclic or network structure. The group L has the same definition as the group Z above. Examples of units of formula (II-1) are H(CH₃)₂SiO_{1/2}, HCH₃SiO_{2/2} and H(C₆H₅)SiO_{2/2}.

The examples of units of formula (II-2) are the same as those given above for the units of formula (I-2).

Examples of polyorganosiloxanes (II) are linear and cyclic compounds, for example:
dimethylpolysiloxanes containing hydrogenodimethylsilyl end groups,
copolymers containing (dimethyl) (hydrogenomethyl) polysiloxane units containing trimethylsilyl end groups,
copolymers containing (dimethyl)(hydrogenomethyl)polysiloxane units containing hydrogenodimethylsilyl end groups,
hydrogenomethylpolysiloxanes containing trimethylsilyl end groups,
cyclic hydrogenomethylpolysiloxanes.

The compound (II) may optionally be a mixture of a dimethylpolysiloxane containing hydrogenodimethylsilyl end groups and of a polyorganosiloxane comprising at least three hydrogenosiloxyl group.

The ratio of the number of hydrogen atoms linked to silicon in the polyorganosiloxane (II) to the total number of groups containing alkenyl unsaturation of the polyorganosiloxane (I) ranges from 0.4 to 10 and preferably from 0.6 to 5.

The bases of silicone polyaddition compositions may comprise only linear polyorganosiloxanes (I) and (II), for instance those described in U.S. Pat. Nos. 3,220,972, 3,697,473 and 4,340,709 or may comprise both branched or network polyorganosiloxanes (I) and (II), for instance those described in U.S. Pat. Nos. 3,284,406 and 3,434,366.

According to one particular embodiment, the following are employed:
at least one linear polyorganosiloxane (I) comprising chains formed from units of formula (I-2) in which c=2, blocked at each of their ends with units of formula (I-1) in which a=1 and b=2, and
at least one linear polyorganosiloxane (II) comprising in its structure at least three hydrogen atoms linked to silicon, located in the chains and/or at chain ends;
and even more particularly:
at least one linear polyorganosiloxane (I) comprising chains formed from units of formula (I-2) in which c=2, blocked at each of their ends with units of formula (I-1) in which a=1 and b=2, and
at least one linear polyorganosiloxane (I) comprising chains formed from units of formula (II-1) in which d=1 and e=1 and optionally units of formula (II-2) in which a=2, blocked at each of their ends with units of formula (II-1) in which d=1 and e=2.

The curing catalysts when (a-2) is employed comprise at least one metal (or compound) of the platinum group, which are also well known. The metals of the platinum group are those known under the name platinoids, this term combining, besides platinum, ruthenium, rhodium, palladium, osmium and iridium. Platinum and rhodium compounds are preferably used. Complexes of platinum and of an organic product described in U.S. Pat. Nos. 3,159,601, 3,159,602, 3,220,972 and European patents EP-A-0-057,459, EP-A-0-1 88,978 and EP-A-0-190,530, and complexes of platinum and of vinylorganosiloxanes described in U.S. Pat. Nos. 3,419,593, 3,715,334, 3,377,432 and 3,814,730 may be used in particular. The catalyst that is generally preferred is platinum. In this case, the weight amount of catalyst (III), calculated by weight of platinum metal, generally ranges from 2 to 400 ppm, preferably from 5 to 200 ppm on the basis of the total weight of the polyorganosiloxanes (I) and (II).

The presence of the additive system (B) in the silicone coating composition (A) according to the invention makes it possible to control the combing strength and the tear strength of the woven, knitted or nonwoven fibrous support. The calcium carbonate does not need to undergo a compatibilization treatment (by heating or surface treatment) in order to be used in the system (B) and therefore cannot be likened to a simple semi-reinforcing filler.

The resin (V) preferably comprises at least one alkenyl residue in its structure. According to one preferred embodiment, the polyorganosiloxane resin (V) comprises siloxyl units Q of formula SiO_{4/2}.

According to another particular embodiment, the polyorganosiloxane resin (V) comprises in its structure from 0.1% to 20% by weight of alkenyl group(s), preferably greater than 4% by weight, the said structure containing siloxyl units of type M, which may be identical or different, siloxyl units of type(s) T, which may be identical or different, and/or Q and optionally siloxyl units of type D.

In a particularly preferred embodiment, the polyorganosiloxane resin (V) comprises at least 2% by weight and preferably at least 5% by weight of siloxyl units of type Q.

These resins (V) are well-known and commercially available branched organopolysiloxane oligomers or polymers. They are in the form of solutions, preferably siloxane solutions. They have in their structure at least two different units chosen from those of formulae R₃SiO_{0.5} (unit M), R₂SiO (unit D), RSiO_{1.5} (unit T) and SiO₂ (unit Q), at least one of these units being a unit T or Q.

The radicals R are identical or different and are selected from among linear or branched C1-C6 alkyl radicals, C2-C4 alkenyl radicals, phenyl, 3,3,3-trifluoropropyl and hydroxy groups. Mention may be made, for example, of: as alkyl radicals R, methyl, ethyl, isopropyl, tert-butyl and n-hexyl radicals, and as alkenyl radicals R, vinyl radicals.

It should be understood that in the resins (V) of the abovementioned type, some of the radicals R are alkenyl radicals.

As examples of branched organopolysiloxane oligomers or polymers, mention may be made of resins MQ, resins MDQ, resins TD and resins MDT, the alkenyl functions possibly being borne by the units M, D and/or T. As examples of resins that are particularly suitable, mention may be made of vinyl MDQ resins with a weight content of vinyl group of from 0.2% to 10% by weight.

In the case where the curable silicone coating composition (A) according to the invention comprises a reinforcing filler, it may be a silica with a BET specific surface area of at least 50 m²/g. The fillers are advantageously processed by treatment with various organosilicon compounds usually used for this purpose. Thus, these organosilicon compounds may be organochlorosilanes, diorganocyclopolysiloxanes, hexaorganodisiloxanes, hexaorganodisilazanes or diorganocyclopolysilazanes (French Patents Nos. FR-A-1-126,884, FR-A-1-136,885 and FR-A-1-236,505, and British Patent No. GB-A-1,024,234).

The curable silicone coating composition (A) according to the invention may also comprise a standard semi-reinforcing or packing filler, for example diatomaceous earth or ground quartz.

Other non-siliceous minerals may be included as semi-reinforcing or packing mineral fillers: carbon black, titanium dioxide, aluminum oxide, hydrated alumina, expanded vermiculite, non-expanded vermiculite, calcium carbonate that has undergone a compatibilization treatment, zinc oxide, mica, talc, iron oxide, barium sulfate, slaked lime, etc.

These fillers may be present in a proportion of from 5% to 30% and preferably from 15% to 25% for the reinforcing fillers and from 5% to 40% and preferably from 10% to 30% for the semi-reinforcing or packing fillers, relative to the total composition.

Without this being limiting, it may be considered that the adhesion promoter (IV) exclusively comprises:
(IV.1) at least one alkoxy organosilane containing, per molecule, at least one C2-C6 alkenyl radical,
(IV.2) at last one organosilicon compound comprising at least one epoxy radical, and
(IV.3) at least one metal chelate M and/or a metal alkoxide of general formula: M(OJ)n, with n=valency of M and J=linear or branched C1- C8 alkyl,
M being selected from the group consisting of: Ti, Zr, Ge, Li, Mn, Fe, Al and Mg.

In accordance with one preferred embodiment of the invention, the alkoxy organosilane (IV.1) of the promoter (IV) is selected from the products having the following general formula: 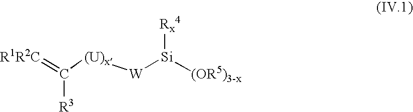
in which formula:
R1, R2 and R3 are identical or different hydrogenated or hydrocarbon-based radicals and represent hydrogen, a linear or branched C1-C4 alkyl radical or a phenyl radical optionally substituted with at least one C1-C3 alkyl radical,
U is a linear or branched C1-C4 alkylene radical,
W is a valency bond,
R4 and R5 are identical or different radicals and represent a linear or branched C1-C4 alkyl radical,
x′=0 or 1, and
x=0 to 2.

Without this being limiting, it may be considered that the vinyltrimethoxysilane is a particularly suitable compound (IV.1).

As regards the organosilicon compound (IV.2), it is envisaged in accordance with the invention to select it from among:
a) either the products (IV.2a) corresponding to the following general formula: 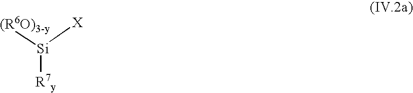
   in which formula:
   R6 is a linear or branched C1-C4 alkyl radical,
   R7 is a linear or branched alkyl radical,
   y is equal to 0, 1, 2 or 3, and
   X has the following formula: 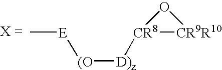
      with:
   E and D, which are identical or different, are each radicals selected from among linear or branched C1-C4 alkyl radicals,
   z is equal to 0 or 1,
   R8, R9 and R10, which are identical or different, are each hydrogen or a linear or branched C1-C4 alkyl radical, and
   R8 and R9 or R10 optionally constituting, together with the two carbons bearing the epoxy function, a 5- to 7-membered alkyl ring,
b) or from the products (IV.2b) which are epoxy-functional polydiorganosiloxanes comprising:
(i) at least one siloxyl unit of formula:

$${X}_{p} {G}_{q} SiO \frac{4 - ( p + q )}{2} \qquad ( IV .2 b1 )$$

in which formula:
X is the radical as defined above for formula (IV.2 a)
G is a monovalent hydrocarbon-based radical, free of unfavorable action on the activity of the catalyst and selected from among alkyl radicals containing from 1 to 8 carbon atoms inclusive, optionally substituted with at least one halogen atom, and also from aryl radicals,
p=1 or 2,
q=0, 1 or 2,
p+q=1, 2 or 3, and
(2i) optionally at least one siloxyl unit of formula:

$${G}_{r} SiO \frac{4 - r}{2} \qquad ( IV .2 b2 )$$

in which formula G has the same definition as above and r is equal to 0, 1, 2 or 3.

As regards the last compound (IV.3) of the adhesion promoter (IV) of the silicone composition (EVF) according to the invention, the preferred products are those for which the metal M of the chelate and/or of the alkoxide (IV.3) is selected from the following list: Ti, Zr, Ge, Li or Mn. It should be pointed out that titanium is more particularly preferred. It may be combined, for example, with an alkoxy radical such as butoxy.

The adhesion promoter (IV) may be formed from:
(IV.1) alone,
(IV.2) alone,
(IV.1)+(IV.2) according to two preferred embodiments:
(IV.1)×(IV.3)
(IV.2)×(IV.3)
   and finally, according to the most preferred embodiment: (IV.1)+(IV.2)+(IV.3).

According to the invention, an advantageous combination for forming the adhesion promoter is as follows:
vinyltrimethoxysilane (VTMO), representative of formula (IV.1),
3-glycidoxypropyltrimethoxysilane (GLYMO), representative of formula (IV.2), and
butyl titanate, representative of formula (IV.3).

In quantitative terms, it may be pointed out that the weight proportions between (IV.1), (IV.2) and (IV.3), expressed as weight percentages relative to the total of the three, are as follows:
(IV.1)≧10, preferably from 15 to 70 and even more preferably from 25 to 65,
(IV.2)≦90, preferably from 70 to 15 and even more preferably from 65 to 25, and
(IV.3)≧1, preferably from 5 to 25 and even more preferably from 8 to 18,
   it being understood that the sum of these proportions of (IV.1), (IV.2) and (IV.3) is equal to 100%.

For better adhesion properties, the weight ratio (IV.2):(IV.1) is preferably from 2:1 to 0.5:1, the ratio 1:1 being more particularly preferred.

Advantageously, the adhesion promoter (IV) is present in a proportion of from 0.1% to 10%, preferably 0.5% to 5% and even more preferably 1% to 3% by weight relative to all of the constituents of the curable silicone coating composition (A).

According to one preferred embodiment, the curable silicone coating composition (A) that is used in the process according to the invention comprises a mixture of:
(1) at least one polyorganosiloxane (I) containing, per molecule, at least two C2-C6 alkenyl groups bonded to silicon,
(2) at least one polyorganosiloxane (II) containing, per molecule, at least two hydrogen atoms bonded to silicon,
(3) a catalytically effective amount of at least one catalyst, comprising at least one metal belonging to the platinum group,
(4) at least one adhesion promoter (IV),
(5) particles of at least one resin (III) comprising at least one (co)polyamide,
(6) an additive system (B) the constituents of which are added sequentially or simultaneously to the mixture, which comprises a mixture of:
at least one polyorganosiloxane resin (V) present at up to 60% by weight relative to the total weight of the mixture and optionally mixed with at least one polyorganosiloxane serving as diluent, and
calcium carbonate (CaCO₃) present at up to 30% by weight relative to the total weight of the mixture;
(7) optionally, at least one reinforcing filler,
(8) optionally, at least one curing inhibitor (VI),
(9) optionally, at least one coloration additive (VII), and
(10) optionally, at least one additive (VIII) for improving the fire resistance.

The curing inhibitor (VI) may be selected from among the following compounds:
polyorganosiloxanes substituted with at least one alkenyl radical that may optionally be in cyclic form, tetramethylvinyltetrasiloxane being particularly preferred,
pyridine,
organic phosphines and phosphites,
unsaturated amides,
alkyl maleates, and
acetylenic alcohols.

These acetylenic alcohols (Cf. FR-B-1,528,464 and FR-A-2,372,874), which are among the preferred hydrosilylation-reaction thermal blockers, have the formula:
(R′)(R″)C(OH)—C≡CH
in which formula:
R′ is a linear or branched alkyl radical, or a phenyl radical;
R″ is H or a linear or branched alkyl radical, or a phenyl radical; the radicals R′ and R″ and the carbon atom α to the triple bond optionally forming a ring;
   the total number of carbon atoms contained in R′ and R″ being at least 5 and preferably from 9 to 20.

For the said alcohols, examples that may be mentioned include:
1-ethynyl-1-cyclohexanol;
3-methyl-1-dodecyn-3-ol;
3,7,11-trimethyl-1-dodecyn-3-ol;
1,1-diphenyl-2-propyn-1-ol;
3-ethyl-6-ethyl-1-nonyn-3-ol;
2-methyl-3-butyn-2-ol;
3-methyl-1-pentadecyn-3-ol;
diallyl maleate or diallyl maleate derivatives.

These α-acetylenic alcohols are commercial products.

Such a retarder (VI) is present in a proportion of up to 3000 ppm and preferably in a proportion of from 100 to 1000 ppm relative to the total weight of the organopolysiloxanes (I) and (II).

As additive (VIII) for improving the fire resistance, examples that may be mentioned include compounds containing a phenyl group substituted with an amino (secondary or tertiary) group. Examples of such additives are described in U.S. Pat. No. 5,516,938. The useful amounts of such additives are generally from 0.01 to 1 part by weight relative to the total amount of the composition.

In a manner that is known per se, the curable silicone coating composition (A) according to the invention may be supplemented with various conventional additives, for instance dyes.

The invention also relates to the curable silicone coating composition (A) as used in the process according to the invention and described above.

According to another of its aspects, the present invention features a two-pack or multi-pack precursor system (C) for the curable silicone coating composition (A) described above. Such a precursor system comprises at least two separate parts A and B, which are intended to be mixed together to form the composition, one of these parts A or B comprising the catalyst and only one polyorganosiloxane species (I) or (II).

When a promoter system (IV-1) (IV-2) and (IV-3) is used, another characteristic of this precursor system is that its part A or B containing the polyorganosiloxane (II) is free of compounds (IV-3) of the promoter (IV) and that its part A or B including the compound (IV-1) of the promoter (IV) does not comprise the catalyst (III).

The viscosity of the parts A and B and of their mutual mixture may be adjusted by varying the amounts of the constituents and by selecting polyorganosiloxanes of different viscosities.

Once mixed together, the parts A and B form a ready-to-use silicone composition, which may be applied to the support by any suitable coating means (for example by doctor blade or roll). A final deposited thickness after curing of from 25 to 300 μm and especially from 50 to 200 μm will generally be targeted. It is not necessary to have a uniform thickness, since, if the surface of the support is not regular, it may result in an irregular deposition.

The compositions according to the invention are heat-cured and/or cured by electromagnetic radiation (radiation of accelerated electrons or “electron beam”).

The compositions according to the invention may be used for covering or coating flexible supports, especially woven, knitted or nonwoven fibrous textiles, and preferably woven, knitted or nonwoven supports made of synthetic fibers, advantageously of polyester or polyamide.

This invention also features a woven, knitted or nonwoven fibrous support coated on one or two faces with an elastomer, which may be obtained:
a) by applying at least 10 g/m² onto one or two face surfaces of a woven, knitted or nonwoven fibrous support of the silicone coating composition (A) described above or of the composition resulting from mixing the parts A and B of the two-pack or multi-pack system (B) described above, and
curing the deposit formed in the preceding step to form an elastomer by heating to a temperature that may be up to 210° C., by electromagnetic radiation or by infrared radiation, or
b) by the process according to the invention described above.

The present invention also features an inflatable bag for protecting an occupant of a vehicle, formed from a support coated according to the procedure of the invention described above.

The present invention also features utilization of the two-pack or multi-pack system (B) according to the invention, of a curable silicone coating composition (A) according to the invention for coating the woven, knitted or nonwoven fibrous support. Preferably, these supports are intended to form inflatable bags for protecting the occupants of vehicles. In one preferred embodiment, the support is a fabric with an open contexture having a porosity>10 I/dm²/min according to ISO standard 9237.

The covering or coating of at least one of the faces of the flexible support material, especially textile (for example polyamide fabric) is useful for manufacturing technical fabrics such as, especially, inflatable bags for the personal protection of the occupants of vehicles, in the event of an impact, tent webs, parachute webs and the like.

In this context, the compositions or the process according to the invention are found to be noteworthy not only for coating supports conventionally used especially in the manufacture of inflatable bags, but also for coating supports with an open contexture. The term “support with an open contexture” means supports with a porosity>10 I/dm²/min according to ISO standard 9237. In the case of a fabric, the open contexture may especially be defined as corresponding to a number of warp and weft yarns per centimetre, the sum of which is less than or equal to 36.

As fabrics that are particularly recommended in the context of the present invention, mention will generally be made of fabrics whose uncoated weight is less than 200 g/m² and especially less than or equal to 160 g/m². Such fabrics, especially polyamide fabrics, having from 16×16 to 18×18 yarns/cm may thus be mentioned, for example fabrics of 470 dtex (decitex) having these characteristics.

It will be noted that substrates, especially fabrics, formed from technical textile fibers, i.e., textile fibers whose properties are improved compared with standard fibers, for example increased fastness, in order to impart particular properties or properties that are reinforced as a function of the applications of the coated support or fabric, may also be used.

This invention thus also features a flexible support, especially a textile support, coated in accordance with the invention and thus having the characteristics and properties indicated above.

By virtue of the properties and characteristics indicated above, inflatable bags for personal protection of the occupants of a vehicle may be made from fabrics of open contexture as described above, in particular polyamide or polyester fabrics, which, once coated, have a good coefficient of friction, good combing strength and tear strength and moreover having optimum properties especially in terms of impermeability, heat protection, porosity, pliability and fire resistance. This makes it possible to produce inflatable bags which have better performance qualities and are less expensive than bags made from the coated fabrics of the prior art. It is thus possible, for an equivalent weight, to increase the thickness of coating without deteriorating the coefficient of friction. In general, the coating that is concerned herein may correspond to the deposition of a single layer onto at least one of the faces of the flexible support material (primary coating). However, it may also concern the deposition of a second layer or optionally a third layer onto at least one of the faces of the already-coated support material (secondary coating) to have in total the desired thickness that ensures the best possible performance qualities in terms of impermeability and favorable feel characteristics.

The examples that follow, of the preparation of compositions and of their application as coating for polyamide fabric according to the process of the invention, will allow the invention to be understood more clearly and will allow its advantages and implementation variants to be highlighted. The performance qualities of the products resulting from the process according to the invention will be illustrated by means of comparative tests.

In order to also further illustrate the present invention and the advantages thereof, the following specific examples are given, it being understood that same are intended only as illustrative and in nowise limitative. In said examples to follow, all parts and percentages are given by weight, unless otherwise indicated.

### EXAMPLES

In these examples, the viscosity is measured using a Brookfield viscometer according to the indications of AFNOR standard NFT-76-106 of May 1982.

### Example 1

1) Definition of the Constituents:

polyorganosiloxane (I): polydimethylsiloxane oil blocked at each of the ends of the chains with a (CH₃)₂ViSiO_{0.5} unit, having a viscosity of 100,000 mPa·s and containing 0.003 Si-Vi function per 100 g of oil [constituent referred to hereinbelow as oil (I)];

Polyorganosiloxane, referred to hereinbelow as diluent (A): a polydimethylsiloxane oil blocked at each of the ends of the chains with a (CH₃)₂ViSiO_{0.5} unit, having a viscosity of 60,000 mPa·s;

Polyorganosiloxane (II): poly(dimethyl)(hydrogenomethyl)siloxane oil blocked at each of the ends of the chains with a (CH₃)₂HSiO_{0.5} unit, having a viscosity of 25 mPa·s and containing in total 0.7 Si—H function per 100 g of oil (including 0.6 Si—H function located in the chain) [constituent referred to hereinbelow as oil (II)];

Catalyst: Pt metal, introduced in the form of an organometallic complex containing 10% by weight of Pt metal, known under the name Karstedt catalyst [constituent referred to hereinbelow as catalyst];

ethynylcyclohexanol 1 (ECH inhibitor);

adhesion promoters (IV), mixture composed of:
(IV-1) vinyltrimethoxysilane (VTMO),
(IV-2) glycidoxypropyltrimethoxysilane (GLYMO), and
(IV-3) butyl titanate Ti(OBu)₄ (TBT);

resin (V): polyorganosiloxane of formula MM^{Vi}DD^{Vi}Q containing 0.8% by weight of vinyl groups (Vi) and comprising 27% by weight of (CH₃)₃SiO_{0.5} units, 0.15% by weight of (CH₃)₂ViSiO_{0.5} units, 60% by weight of (CH₃)₂SiO units, 2.4% by weight of (CH₃)ViSiO units and 9.6% by weight of SiO₂ units and a residue of OH groups;

calcium carbonate, CaCO₃, (Albacar© 5970), which has not undergone a compatibilization treatment (heating or surface functionalization);

Orgasol® 2002 ES3 NAT3 (company: Atofina), polyamide-12 beads, mean particle diameter: 30 μm.

2) Procedure and Results:

a) A composition is prepared from a two-pack precursor:

A control composition (C-1) is obtained by mixing together, at room temperature, 100 parts by weight of a part A and 10 parts by weight of a part B of a two-pack system (see composition in Table 1).

A composition (I-1) according to the invention is obtained by mixing together, at room temperature:

125 parts by weight of a part A-1 obtained by mixing 100 parts by weight of part A of composition C-1 and 25 parts by weight of Orgasol® 2002 ES3 NAT3 beads, and

10 parts by weight of a composition B-1 the composition of which is identical to that of part B of composition C-1

b) each mixture (C-1 and I-1) is coated (variable coating rate, expressed in g/m²), to form a deposit using doctor blades or rolls, on a desized type 6.6 polyhexamethyleneadipamide fabric with a yarn count of 235 decitex (dtex), and

c) the resulting layer is cured for 80 seconds at 180° C. in a Mathis oven to obtain an elastomer. The results of the comparative tests are reported in Tables II to IV.

The measurements of the coefficient of friction (Ks) are performed according to standard NFQ 03-082. Table II shows the measurements of the coefficients of friction obtained by rubbing on a glass plate. Table III shows the measurements of the coefficients of friction obtained by rubbing the sample of coated fabric on itself, coated face on coated face.

TABLE I

| | |
|---|---|
| Compositions | C-1 |

Part A

| | |
|---|---|
| Number of parts by | |
| weight | |
| Composition containing | 48 |
| 40% by weight of resin | |
| (V) and 60% by weight | |
| of diluent (A) | |
| Ethynylcyclohexanol 1 | 0.025 |
| High-viscosity oil (I) | 28 |
| CaC0₃ | 16 |
| Oil (II) | 6 |
| VTMO | 1 |
| GLYMO | 1 |

Part B

| | |
|---|---|
| Composition containing | 45 |
| 40% by weight of resin | |
| (V) and 60% by weight | |
| of diluent (A) | |
| High-viscosity oil (I) | 51 |
| TBT | 4 |
| Catalyst | 0.02 |

TABLE II

| C-1 | | I-1 | |
|---|---|---|---|
| Deposited mass | Coefficient of | Deposited mass | Coefficient of |
| (g/m²) | friction (Ks) | (g/m²) | friction (Ks) |
| 23 | 0.27 | 27 | 0.29 |
| 26 | 0.27 | 33 | 0.3 |
| 35 | 0.82 | 37 | 0.33 |
| 37 | 1.00 | 43 | 0.33 |
| 43 | 1.75 | | |

TABLE III

| C-1 | | I-1 | |
|---|---|---|---|
| Deposited mass | Coefficient of | Deposited mass | Coefficient of |
| (g/m²) | friction (Ks) | (g/m²) | friction (Ks) |
| | | 27 | 0.31 |
| 36 | 0.37 | 33 | 0.41 |
| 40 | 1.00 | 37 | 0.38 |
| 41 | 0.91 | 43 | 0.59 |

It is found that composition I-1 according to the invention leads to coefficients of friction (COF) that are smaller than those obtained with the control composition C-1 when the deposits are comparable in terms of amount per unit area of the coated fabric.

Next, the samples of coated fabric were tested according to standard methods in the art of airbag manufacture. The results are collated in Table IV below.

The test of resistance to creasing and to abrasion (“scrub” test) (ISO standard 5981 A) reflects the adhesion and the aging behavior of the composition. This test consists in subjecting the fabric firstly to a shear movement using two jaws pinching the two opposite edges of a sample and driven in an alternating motion relative to each other, and secondly to an abrasion by contact with a mobile support.

TABLE IV

| | Test method | | | | |
|---|---|---|---|---|---|
| | Measuring unit | | | | |
| | Brookfield | C-1 | | I-1 | |
| Viscosity | mPa · s | 47 000 | | 105 000 | |
| Combing | DIN 54301 | 33 g/m² | 526 | 27 g/m² | 730 |
| strength | newtons (N) | | | | |
| | | 36 g/m² | 742 | 33 g/m² | 770 |
| | | 41 g/m² | 845 | 33 g/m² | 784 |
| | | | | 37 g/m² | 795 |
| | | | | 43 g/m² | 844 |
| Tear strength | ISO 13937 | 33 g/m² | 142 | 27 g/m² | 119 |
| | newtons (N) | | | | |
| | | 36 g/m² | 140 | 33 g/m² | 132 |
| | | 41 g/m² | 149 | 33 g/m² | 127 |
| | | | | 37 g/m² | 142 |
| | | | | 43 g/m² | 123 |
| “Scrub” test | ISO 5981 A | 33 g/m² | >1000 | 27 g/m²\| | 1000 |
| | Friction number | | | | |
| | | 36 g/m² | >1000 | 33 g/m² | 1000 |
| | | 41 g/m² | >1000 | 33 g/m²\| | 1200 |
| | | | | 37 g/m² | 1000 |
| | | | | 43 g/m² | 1200 |
| Fire resistance | ISO 3795 | 23 g/m² | 59 | 27 g/m² | self- |
| | mm/min | | | | extinguishable |
| | | 35 g/m² | self- | 33 g/m² | self- |
| | | | extinguishable | | extinguishable |
| | | 43 g/m² | self- | 43 g/m² | self- |
| | | | extinguishable | | extinguishable |

It is thus found that, for an equivalent coating deposit, formula I-1 makes it possible to conserve the useful properties of the fabric as obtained with formula C-1, while at the same time enhancing the coefficient of friction.

Each patent, patent application, publication and literature article/report cited or indicated herein is hereby expressly incorporated by reference.

While the invention has been described in terms of various specific and preferred embodiments, the skilled artisan will appreciate that various modifications, substitutions, omissions, and changes may be made without departing from the spirit thereof. Accordingly, it is intended that the scope of the present invention be limited solely by the scope of the following claims, including equivalents thereof.

1. A process for improving the coefficient of friction of a woven, knitted or nonwoven fibrous support, comprising the following steps:
a) providing a curable silicone coating composition (A) which comprises:
(1) components (a-1) or (a-2):
(a-1) at least one polyorganosiloxane curable by the action of a catalyst based on at least one organic peroxide, or
(a-2) a polyorganosiloxane blend curable by polyaddition reactions, comprising:
at least one polyorganosiloxane (I) containing, per molecule, at least two C2-C6 alkenyl groups bonded to silicon, and
at least one polyorganosiloxane (II) containing, per molecule, at least two hydrogen atoms bonded to silicon;
(2) an effective amount of a curing catalyst which comprises: when (a-1) is present, at least one organic peroxide, and when (a-2) is present, at least one metal or compound of the platinum group;
(3) particles of at least one resin (III) comprising at least one (co)polyamide;
(4) optionally, at least one reinforcing filler;
(5) at least one adhesion promoter (IV);
(6) optionally, an additive system (B), the constituents of which are added sequentially or simultaneously, comprising a mixture of:
at least one polyorganosiloxane resin (V) present at up to 60% by weight relative to the total weight of the mixture and optionally mixed with at least one polyorganosiloxane diluent, and
calcium carbonate (CaCO₃) present at up to 30% by weight relative to the total weight of the mixture;
(7) optionally, at least one curing inhibitor (VI);
b) applying at least 10 g/m² to one or two face surfaces of a woven, knitted or nonwoven fibrous support of the silicone coating composition (A) provided in step a); and
c) curing the deposit formed in step b) to form an elastomer by heating to a temperature of up to 210° C., by electromagnetic radiation or by infrared radiation.

2. The process for improving the coefficient of friction of a woven, knitted or nonwoven fibrous support as defined by claim 1, in which the curable silicone coating composition (A) comprises a mixture of:
(1) at least one polyorganosiloxane (I) containing, per molecule, at least two C2-C6 alkenyl groups bonded to silicon;
(2) at least one polyorganosiloxane (II) containing, per molecule, at least two hydrogen atoms bonded to silicon;
(3) a catalytically effective amount of at least one catalyst, comprising at least one metal belonging to the platinum group;
(4) at least one adhesion promoter (IV);
(5) particles of at least one resin (III) comprising at least one (co)polyamide;
(6) an additive system (B) which comprises a mixture of:
at least one polyorganosiloxane resin (V) present at up to 60% by weight relative to the total weight of the mixture and optionally mixed with at least one polyorganosiloxane diluent, and
calcium carbonate (CaCO₃) present at up to 30% by weight relative to the total weight of the mixture;
(7) optionally, at least one reinforcing filler;
(8) optionally, at least one curing inhibitor (VI);
(9) optionally, at least one coloration additive (VII); and
(10) optionally, at least one additive (VIII) for improving fire resistance.

3. The process for improving the coefficient of friction of a woven, knitted or nonwoven fibrous support as defined by claim 1, in which the particles of the resin (III) are of spherical shape.

4. The process for improving the coefficient of friction of a woven, knitted or nonwoven fibrous support as defined by claim 3, in which the mean diameter of the particles of the resin (III) ranges from 5 to 100 μm.

5. The process for improving the coefficient of friction of a woven, knitted or nonwoven fibrous support as defined by claim 1, in which the particles of the resin (III) comprise at least one (co)polyamide selected from the group consisting of polyamide-6, polyamide-6.6, polyamide-4, polyamide-11, polyamide-12, polyamides 4-6, 6-10, 6-12, 6-36 and 12-12, and copolymers and blends thereof.

6. The process for improving the coefficient of friction of a woven, knitted or nonwoven fibrous support as defined in claim 5, in which the particles of the resin (III) comprise polyamide-12.

7. The process for improving the coefficient of friction of a woven, knitted or nonwoven fibrous support as defined by claim 1, in which the particles of the resin (III) are present at up to 40% by weight relative to the total weight of the mixture.

8. The process for improving the coefficient of friction of a woven, knitted or nonwoven fibrous support as defined by claim 1, in which the particles of the resin (III) are present at from 1% to 30% by weight relative to the total weight of the mixture.

9. The process for improving the coefficient of friction of a woven, knitted or nonwoven fibrous support as defined by claim 1, in which the particles of the resin (III) are present at from 5% to 20% by weight relative to the total weight of the mixture.

10. The process for improving the coefficient of friction of a woven, knitted or nonwoven fibrous support as defined by claim 1, in which the adhesion promoter (IV) for the curable silicone coating composition (A) comprises:
(IV.1) at least one alkoxy organosilane containing, per molecule, at least one C2-C6 alkenyl group;
(IV.2) at last one organosilicon compound comprising at least one epoxy radical; and
(IV.3) at least one metal chelate M and/or a metal alkoxide of general formula: M(OJ)n, wherein n=valency of M and J=linear or branched C1-C8 alkyl radical and M is selected from the group consisting of Ti, Zr, Ge, Li, Mn, Fe, Al and Mg.

11. The process for improving the coefficient of friction of a woven, knitted or nonwoven fibrous support as defined by claim 10, in which the alkoxy organosiloxane (IV.1) of the promoter (IV) has the following general formula: 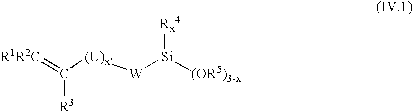
in which formula R1, R2 and R3 are identical or different and are each hydrogen, a linear or branched C1-C4 alkyl radical or a phenyl radical optionally substituted with at least one C1-C3 alkyl radical; U is a linear or branched C1-C4 alkylene radical; W is a valency bond; R4 and R5 are identical or different and are each a linear or branched C1-C4 alkyl radical; x′=0 or 1; and x=0 to 2.

12. The process for improving the coefficient of friction of a woven, knitted or nonwoven fibrous support as defined by claim 10, in which the organosilicon compound (IV.2) of the promoter (IV) comprises:
a) either one or more compounds (IV.2a) having the following general formula: 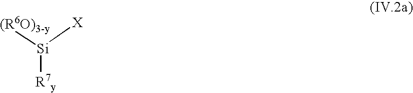
in which formula R6 is a linear or branched C1- C4 alkyl radical; R7 is a linear or branched alkyl radical; y is equal to 0, 1, 2 or 3; and X has the following formula: 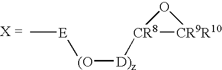
in which E and D, which may be identical or different, are each a linear or branched C1-C4 alkyl radical; z is equal to 0 or 1; R8, R9 and R10, which may be identical or different, are each hydrogen or a linear or branched C1-C4 alkyl radical, and with the proviso that R8 and R9 or R10 may together form, with the two carbons bearing the epoxy function, a 5- to 7-membered alkyl ring,
b) or from one or more compounds (IV.2b) comprising epoxy-functional polydiorganosiloxanes containing:
(i) at least one siloxyl unit of formula:
$${X}_{p} {G}_{q} SiO \frac{4 - ( p + q )}{2} \qquad ( IV .2 b1 )$$
in which formula X is the radical as defined above for formula (IV.2 a); G is a monovalent hydrocarbon-based group, free of unfavorable action on the activity of the catalyst, and selected from among alkyl radicals having from 1 to 8 carbon atoms inclusive, optionally substituted with at least one halogen atom, and also from among aryl radicals; p=1 or 2; q=0, 1 or 2; p+q=1, 2 or 3, and
(2i) optionally, at least one siloxyl unit of formula:
$${G}_{r} SiO \frac{4 - r}{2} \qquad ( IV .2 b2 )$$
in which formula G is as defined above and r is equal to 0, 1, 2 or 3.

13. The process for improving the coefficient of friction of a woven, knitted or nonwoven fibrous support as defined by claim 10, in which the metal M of the chelate and/or of the alkoxide (IV.3) is Ti, Zr, Ge, Li or Mn.

14. The process for improving the coefficient of friction of a woven, knitted or nonwoven fibrous support as defined by claim 10, in which the adhesion promoter (IV) comprises a mixture of:
vinyltrimethoxysilane (VTMO), representative of formula (IV.1),
3-glycidoxypropyltrimethoxysilane (GLYMO), representative of formula (IV.2), and
butyl titanate, representative of formula (IV.3).

15. The process for improving the coefficient of friction of a woven, knitted or nonwoven fibrous support as defined by claim 1, in which the polyorganosiloxane (I) contains:
(i) siloxyl units of formula:
$${R}_{a}^{1} {Z}_{b} SiO \frac{4 - ( a + b )}{2} \qquad ( I \text{-} 1 )$$
in which formula the symbols R¹ are each an alkenyl group; the symbols Z, which may be identical or different, are each a monovalent hydrocarbon-based group, free of unfavorable action on the activity of the catalyst, and selected from among alkyl radicals having from 1 to 8 carbon atoms inclusive, optionally substituted with at least one halogen atom, and also from among aryl radicals; a is 1 or 2; b is 0, 1 or 2; and the sum a+b is equal to 1, 2 or 3, and, optionally,
(ii) other siloxyl units of formula:
$$Zc SiO \frac{4 - c}{2} \qquad ( I \text{-} 2 )$$
in which formula Z is as defined above and c is 0, 1, 2 or 3.

16. The process for improving the coefficient of friction of a woven, knitted or nonwoven fibrous support as defined by claim 1, the curable silicone coating composition (A) comprising a polyorganosiloxane (II) containing:
siloxyl units of formula:
$${H}_{d} {L}_{e} SiO \frac{4 - ( d + e )}{2} \qquad ( II \text{-} 1 )$$
in which the groups L, which may be identical or different, are each a monovalent hydrocarbon-based group, free of unfavorable action on the activity of the catalyst, and selected from among alkyl radicals having from 1 to 8 carbon atoms inclusive, optionally substituted with at least one halogen atom, d is 1 or 2, e is 0, 1 or 2, the sum d+e is equal to 1, 2 or 3, and
optionally, at least other units of mean formula:
$${L}_{g} SiO \frac{4 - g}{2} \qquad ( II \text{-} 2 )$$
in which the groups L are as defined above and q is equal to 0, 1, 2 or 3.

17. The process for improving the coefficient of friction of a woven, knitted or nonwoven fibrous support as defined by claim 1, the curable silicone coating composition (A) comprising a polyorganosiloxanes blend (a-2) in which the proportions of the polyorganosiloxanes (I) and (II) are such that the molar ratio of the hydrogen atoms bonded to silicon in (II) to the alkenyl radicals bonded to silicon in (I) ranges from 0.4 to 10.

18. The process for improving the coefficient of friction of a woven, knitted or nonwoven fibrous support as defined by claim 1, the curable silicone coating composition (A) comprising a polyorganosiloxanes blend (a-2) in which the proportions of the polyorganosiloxanes (I) and (II) are such that the molar ratio of the hydrogen atoms bonded to silicon in (II) to the alkenyl radicals bonded to silicon in (I) ranges from 0.6 to 5.

19. A curable silicone coating composition (A) comprising:
(1) components (a-1) or (a-2):
(a-1) at least one polyorganosiloxane curable by the action of a catalyst based on at least one organic peroxide, or
(a-2) a polyorganosiloxane blend curable by polyaddition reactions, comprising:
at least one polyorganosiloxane (I) containing, per molecule, at least two C2-C6 alkenyl groups bonded to silicon, and
at least one polyorganosiloxane (II) containing, per molecule, at least two hydrogen atoms bonded to silicon;
(2) an effective amount of curing catalyst which comprises: when (a-1) is present, at least one organic peroxide, and when (a-2) is present, at least one metal or compound of the platinum group;
(3) particles of at least one resin (III) comprising at least one (co)polyamide;
(4) optionally, at least one reinforcing filler;
(5) optionally, at least one curing inhibitor (VI);
(6) optionally, at least one coloration additive (VII);
(7) optionally, at least one additive (VIII) for improving fire resistance;
(8) at least one adhesion promoter (IV);
(9) optionally, an additive system (B) for improving combing strength and tear strength which comprises a mixture of:
at least one polyorganosiloxane resin (V) present at up to 60% by weight relative to the total weight of the mixture and optionally mixed with at least one polyorganosiloxane diluent, and
calcium carbonate (CaCO₃) present at up to 30% by weight relative to the total weight of the mixture.

20. The curable silicone coating composition (A) as defined by claim 19, comprising:
(1) at least one polyorganosiloxane (I) containing, per molecule, at least two C2-C6 alkenyl groups bonded to silicon;
(2) at least one polyorganosiloxane (II) containing, per molecule, at least two hydrogen atoms bonded to silicon;
(3) a catalytically effective amount of at least one catalyst (III) of at least one metal belonging to the platinum group;
(4) particles of at least one resin (III) comprising at least one (co)polyamide;
(5) at least one adhesion promoter (IV);
(6) an additive system (B) which comprises a mixture of:
at least one polyorganosiloxane resin (V) present at up to 60% by weight relative to the total weight of the mixture and optionally mixed with at least one polyorganosiloxane diluent, and
calcium carbonate (CaCO₃) present at up to 30% by weight relative to the total weight of the mixture;
(7) optionally, at least one curing inhibitor (VI);
(8) optionally, at least one reinforcing filler;
(9) optionally, at least one coloration additive (VII); and
(10) optionally, at least one additive (VIII) for improving fire resistance.

21. The curable silicone coating composition (A) as defined by claim 19, in which the particles of the resin (III) are of spherical shape.

22. The curable silicone coating composition (A) as defined by claim 21, in which the mean diameter of the particles of the resin (III) ranges from 5 to 100 μm.

23. The curable silicone coating composition (A) as defined by claim 19, in which the particles of the resin (III) comprise (co)polyamides selected from the group consisting of polyamide-6, polyamide-6.6, polyamide-4, polyamide-11, polyamide-12, polyamides 4-6, 6-10, 6-12, 6-36 and 12-12, and copolymers and blends thereof.

24. The curable silicone coating composition (A) as defined by claim 23, in which the particles of the resin (III) comprise polyamide-12.

25. The curable silicone coating composition (A) as defined by claim 19, in which the adhesion promoter (IV) comprises a mixture of:
vinyltrimethoxysilane (VTMO);
3-glycidoxypropyltrimethoxysilane (GLYMO);
butyl titanate.

26. The curable silicone coating composition (A) as defined by claim 19, in which the particles of the resin (III) are present at up to 40% by weight relative to the total weight of the mixture.

27. The curable silicone coating composition (A) as defined by claim 19, in which the particles of the resin (III) are present at from 1% to 30% by weight relative to the total weight of the mixture.

28. The curable silicone coating composition (A) as defined by claim 19, in which the particles of the resin (III) are present at from 5% to 20% by weight relative to the total weight of the mixture.

29. Two-pack or multi-pack precursor system (C) for the curable silicone coating composition (A) as defined by claim 19, comprising:
two separate parts A and B, which when mixed together form the composition (A), and
one of these parts A or B comprises the catalyst and only one polyorganosiloxane species (I) or (II).

30. A woven, knitted or nonwoven fibrous support coated on at least one of the face surfaces thereof with an elastomer polymerizate of the curable silicone coating composition (A) as defined by claim 19.

31. The woven, knitted or nonwoven fibrous support coated on one or two face surfaces with an elastomer as defined by claim 30, prepared by:
a) applying at least 10 g/m² onto one or two face surfaces of the woven, knitted or nonwoven fibrous support of the curable silicone coating composition (A), and
b) curing the deposit formed in the preceding step to form an elastomer by heating to a temperature of up to 210° C. or by electromagnetic radiation, or by infrared radiation.

32. The coated woven, knitted or nonwoven fibrous support as defined by claim 30, comprising an inflatable airbag.
